(19) United States
(12) Patent Application Publication
(10) Pub. No.: US 2018/0195524 A1
(43) Pub. Date: Jul. 12, 2018

(54) COMPRESSOR WHEEL AND USE OF THE COMPRESSOR WHEEL

(71) Applicant: BASF SE, Ludwigshafen (DE)

(72) Inventors: Florian HENNENBERGER, Heppenheim (DE); Georg GRAESSEL, Ludwigshafen (DE); Gerhard BOHRMANN, Boehl-Iggelheim (DE); Daniel HOFER, llvesheim (DE)

(73) Assignee: BASF SE, Ludwigshafen (DE)

(21) Appl. No.: 15/738,302

(22) PCT Filed: Jun. 23, 2016
(86) PCT No.: PCT/EP2016/064553

§ 371 Date: Dec. 20, 2017

(30) Foreign Application Priority Data
Jun. 24, 2015 (EP) 15173688.1

(51) Int. Cl. F04D 29/28; F04D 29/02

(52) U.S. Cl. CPC F04D 29/284; F05D 2300/436; F04D 29/023; F04D 29/281

(57) ABSTRACT

The invention relates to a compressor wheel for a high-speed compressor composed of a polymer material, having a wheel front side (6), a wheel rear side (11) and a wheel hub (3), wherein the wheel front side (6) has a curvature, by virtue of which the distance between a plane extending radially through the outer circumference (15) of the wheel front side (6) and the surface of the wheel front side (6) increases from the outer circumference (15) toward the wheel hub (3), and guide vanes (7) are arranged on the wheel front side (6). The wheel hub (3) projects in an axial direction on the wheel rear side (11), and reinforcing ribs (13) extend from the wheel hub (3) toward the outer circumference (15), wherein the distance between a plane extending radially through the outer circumference (15) of the wheel rear side (11) and the trailing edge (19) of the reinforcing ribs (13) increases from the outer circumference (15) of the wheel rear side (11) toward the wheel hub (3).

The invention furthermore relates to the use of the compressor wheel.

The invention starts from a compressor wheel for a high-speed compressor composed of a polymer material, having a wheel front side, a wheel rear side and a wheel hub, wherein the wheel front side has a curvature, by virtue of which the distance between a plane extending radially through the outer circumference of the wheel front side and the surface of the wheel front side increases from the outer circumference toward the wheel hub, and guide vanes are arranged on the wheel front side.

Compressor wheels are used, for example, in electrically driven compressors of internal combustion engines or in domestic appliances, e.g. bagless vacuum cleaners. Particularly for compressors of internal combustion engines, the compressor wheels are currently manufactured from metal owing to the high temperatures which occur and to the high speeds of rotation. However, these have a high density in comparison with plastics and therefore also have a relatively high mass. However, this leads to high forces acting on the compressor wheel and, associated with this, to a high required driving torque for the compressor wheel.

To reduce the necessary starting power of the motor or engine, there is therefore a desire to reduce the masses of the individual components. The use of plastics as a replacement for metallic materials seems appropriate for this purpose. Particularly in the case of high-speed compressor wheels, however, it is not possible to achieve the endurance of metallic materials, even with high performance plastics. The reason for this is very high bending stresses in the entire component owing to the centrifugal forces which occur at the high speeds of rotation of up to 250,000 rpm.

The requirement for compressor wheels with a low mass is increasing since electrically driven compressors are increasingly being used as additional equipment to boost the power of internal combustion engines and to save fuel. In this context, it is necessary to use a compressor wheel of high endurance owing to the fact that the electrically driven compressor does not run continuously along with the engine.

From the sector of bagless vacuum cleaners, it is already known that compressor wheels of polyetheretherketone (PEEK) can be used. A compressor wheel of this kind is described in Konstruktion & Engineering, ke April 2005, page 86, for example. Motortechnische Zeitschrift, September 2009, Volume 70, Issue 9, pages 652 to 656 furthermore reveals plans to manufacture compressor wheels from PEEK. However, it is also explained here that use is not possible in the region of relatively high-compression turbochargers when building engines owing to the temperatures which occur.

A compressor wheel for an internal combustion engine, for example in a motor vehicle, is described in WO-A 2004/016952. The compressor wheel comprises ribs on the rear side to allow producing the compressor wheel from plastic material. Due to the form of the exhaust-gas turbocharger shown in WO-A 2004/016952 it is necessary that the compressor wheel has no parts on the rear side which protrude downwards. However, it has shown that particularly at high speeds of rotation such a design results in undesirable deformation during operation by which collisions of the compressor wheel with the housing may occur.

It is therefore the object of the present invention to provide a compressor wheel which has a low mass and, in particular, can be operated with a high endurance at the high speeds of rotation and temperatures which occur in a turbo compressor.

This object is achieved by a compressor wheel for a high-speed compressor composed of a polymer material, having a wheel front side, a wheel rear side and a wheel hub, wherein the wheel front side has a curvature, by virtue of which the distance between a plane extending radially through the outer circumference of the wheel front side and the surface of the wheel front side increases from the outer circumference toward the wheel hub, and guide vanes are arranged on the wheel front side, wherein the wheel hub projects in an axial direction on the wheel rear side, and reinforcing ribs extend from the wheel hub toward the outer circumference, wherein the distance between a plane extending radially through the outer circumference of the wheel rear side and the trailing edge of the reinforcing ribs increases from the outer circumference of the wheel rear side toward the wheel hub.

The reinforcing ribs on the wheel rear side have the advantage that all the parts of the compressor wheel can be embodied with substantially the same wall thickness. In particular, it is thereby possible to avoid embodying the compressor wheel with a large wall thickness in a direction toward the hub, which can lead to the formation of cavities and dimensional inaccuracies due to shrinkage, especially in the case of production from plastics. The shrinkage and the associated dimensional inaccuracies can lead to nonuniform running and hence to damage during the operation of the compressor wheel. Cavities in the polymer lead to instabilities since the polymer cannot absorb the force uniformly.

In the context of the present invention, “project in an axial direction on the wheel rear side” means that the end of the wheel hub in the axial direction is visible on the side facing away from the guide vanes, wherein the wheel rear side is the side of the compressor wheel on which no guide vanes are arranged. For this purpose, the lower end of the wheel hub, the maximum circumference of the compressor wheel and the upper end of the wheel hub follow one another in an axial direction.

Through the configuration in such a way that the wheel hub projects in an axial direction on the wheel rear side and reinforcing ribs extend from the wheel hub toward the outer circumference, wherein the distance between a plane extending radially through the outer circumference of the wheel rear side and the trailing edge of the reinforcing ribs increases from the outer circumference of the wheel rear side toward the wheel hub, a stability which allows stable and durable operation of the compressor wheel, even at high temperatures of up to 200° C., depending on the plastic selected, is surprisingly achieved. In particular, the bending stresses which occur due to the high speeds of rotation can be absorbed, and the compressor wheel is not damaged. The low deformation at high speeds of rotation has the additional positive effect that only low leak-age flows occur and thus the efficiency of the compressor is barely reduced.

Configuration with the ribs has the additional advantage that the wall thicknesses of the individual sections of the compressor wheel do not differ by more than 100%. This makes it possible to produce the compressor wheel from a polymer-based material without the occurrence of excessive shrinkage of the material and hence unwanted deformation of the compressor wheel.

Moreover, owing to the thin wall thicknesses which are possible, no cavities arise during the cooling of the polymer material. A stable compressor wheel without production-related weak-points and with only small tolerances in the dimensions of the compressor wheel is thus obtained.

The reinforcing ribs can have a straight or a curved trailing edge. If the trailing edge is curved, the trailing edge extends concavely from the outside toward the hub. It is particularly preferred here if the curvature is such that the trailing edge does not intersect the plane extending radially through the outer circumference. As an alternative, it is also possible to make the trailing edge linear, that is to say without a curvature, from the outer circumference toward the hub. However, configuration of the trailing edge with a curvature is preferred. In this case, the curvature can be in the form of a circular arc, elliptical, parabolic or hyperparabolic.

In one embodiment of the invention, the wheel hub is surrounded on the wheel rear side by a concentric ring, and reinforcing ribs extend between the wheel hub and the concentric ring and from the concentric ring toward the outer circumference. The ring concentric with the wheel hub extending around the wheel hub allows additional reinforcement of the compressor wheel. Here, the concentric ring projects as far out in an axial direction as the wheel hub on the wheel rear side, at the maximum. It is particularly preferred if the concentric ring projects on the wheel rear side to such an extent that it ends flush with the reinforcing ribs, which extend from the outer circumference to the concentric ring and from the concentric ring to the wheel hub. It is preferred here if the reinforcing ribs between the concentric ring and the wheel hub have a trailing edge which extends radially perpendicularly to the axis of the compressor wheel.

Particularly in the case of a small diameter of the wheel hub and a correspondingly small outer circumference of the wheel hub, it is preferred if the number of reinforcing ribs between the wheel hub and the concentric ring is smaller than the number of reinforcing ribs which extend from the concentric ring toward the outer circumference. Here, the smaller number of reinforcing ribs is desired particularly for the sake of simpler manufacture since the distance between the ribs can thus be made greater than if all the ribs extended from the outer circumference to the wheel hub.

Furthermore, the concentric ring allows to increase the total number of ribs compared to a construction without additional concentric ring und thus to further improve stability. This is particularly required for fast rotating compressor wheels, i.e. compressor wheels which are operated at rotational speeds of more than 50,000 min⁻¹, to reduce occurring vibrations at the rim of the compressor wheel and thereby to prevent that the compressor wheel collides with a housing which encloses the compressor wheel during operation.

If a smaller number of reinforcing ribs is provided between the wheel hub and the concentric ring, it is particularly preferred if the number of reinforcing ribs between the wheel hub and the concentric ring is half the number of reinforcing ribs between the concentric ring and the outer circumference of the compressor wheel. In this case, the reinforcing ribs between the wheel hub and the concentric ring form an extension of each second reinforcing rib which extends from the outer circumference to the concentric ring.

The reinforcing ribs can be made straight or curved and can be aligned at an angle in a range of from 0 to 45° relative to the radial direction. The ribs are preferably aligned at an angle in a range of from 0 to 300, particularly preferably in a range of from 0 to 15°. It is particularly preferred if the ribs are aligned radially, that is to say at an angle of 0° relative to the radial direction.

If a concentric ring is provided, it is preferred if the reinforcing ribs between the wheel hub and the concentric ring are aligned in a radial direction. In this case, the reinforcing ribs between the concentric ring and the outer circumference can extend at an angle which differs from 0°. Moreover, the reinforcing ribs can be straight or curved.

However, it is particularly preferred if all the reinforcing ribs extend in a radial direction, and, in this case too, the reinforcing ribs can be straight or curved.

In the case of a curved profile of the reinforcing ribs, it is possible, for example, for the reinforcing ribs extending toward the outer circumference to be curved or s-shaped. However, a straight profile of the reinforcing ribs is preferred for manufacturing reasons.

Metals, ceramics or polymers can be used as a material for the compressor wheel. Owing to their low weight, plastics should preferably be used as a material. Especially when the compressor wheel is used in a turbo compressor in an engine for a motor vehicle, it is necessary that the material should be sufficiently temperature-stable, preferably up to a temperature of 200° C. Nevertheless, the same polymers are preferably used as materials for the compressor wheel, irrespective of the application. Both temperature-stable thermoplastics and temperature-stable thermosets can be used in this context.

Suitable polymer materials which are used to produce the compressor wheel are preferably selected from polyaryletherketones (PAEK), polysulfones (PSU), polyphenylenesulfone (PPSU), polyetherimides (PEI), polyamides (PA), polyethersulfones (PESU), polyphenylene sulfides (PPS), polyvinylidene fluoride (PVDF), epoxy resins (EP) and polyesters.

Suitable polyaryletherketones are polyetheretherketone (PEEK), polyacryletherketoneether-ketoneketone (PEKEKK), polyetherketone (PEK), polyetherketoneketone (PEKK) or polyether-etherketoneketone (PEEKK), for example.

If a polyamide is used as a polymer, the polyamide is preferably selected from PA 46, PA 6, PA 66, PA 6/6T, PA 610, PA 11 and PA 12.

In this context, polyaryletherketones or polyethersulfones are particularly preferred as polymers.

In order to obtain a sufficient stability for the compressor wheel made of polymer material, it is preferred if the polymer material is reinforced. Both fillers in the form of powder and those in the form of fibers can be used here. In the case of fillers in the form of fibers, long fibers or short fibers are used, in particular. In this context, fibers with a length in a range of from 1.7 to 10 mm are referred to as long fibers and fibers with a length in a range of from 0.01 to 1.7 mm are referred to as short fibers. Irrespective of whether short fibers or long fibers are used, the fiber diameter is preferably in a range of from 5 to 20 μm. If glass fibers are used, the fiber diameter is preferably in a range of from 10 to 20 μm, while, in the case of carbon fibers, it is preferably in a range of from 5 to 10 μm.

Fillers in the form of powder preferably have a mean diameter in a range of from 0.5 to 50 μm. Suitable fillers in the form of powder are talc, graphite, calcium carbonate, calcium fluoride, zinc oxide, wollastonite, magnesium oxide and kaolin, for example.

Suitable fillers in the form of fibers are glass fibers, carbon fibers, mineral fibers or aramid fibers. Carbon fibers or glass fibers are particularly preferred in this context. Here, the carbon fibers preferably have a diameter in a range of from 5 to 10 μm and a length in a range of from 50 to 500 μm when milled carbon fibers are used and a length in a range of from 1 to 5 mm when chopped carbon fibers are used. It is also possible in this context to use mixtures of different fiber lengths in any desired mixing ratio, e.g. one portion with a length in a range of from 50 to 250 μm and one portion with a length in a range of from 3 to 5 mm.

If glass fibers are used, these preferably have a diameter in a range of from 10 to 14 μm and a length in a range of from 50 to 250 μm when using milled glass fibers and a length in a range of from 3 to 5 mm when using chopped glass fibers. Here too, the use of mixtures of different fiber lengths in any desired mixing ratio is possible, e.g. one portion with a length in a range of from 50 to 250 μm and one portion with a length in a range of from 3 to 5 mm.

In order to adjust the properties of the polymer, it is possible to add further additives in addition to the fillers in the form of fibers or powder. Commonly used additives are, for example, harden-ers, cross-linking agents, plasticizers, catalysts, toughness modifiers, adhesion promoters, fillers, mold release agents, blends with other polymers, stabilizers or mixtures of two or more of these components. Additives or optionally also co-monomers which can be used to adjust the properties of the polymers are known to those skilled in the art.

The compressor wheel according to the invention is suitable as a compressor wheel in an exhaust turbocharger, an electrically driven compressor for engines, a vacuum cleaner, a blower, a compressor, a fan or a vapor extraction hood, for example.

Embodiments of the invention are shown in the figures and are explained in greater detail in the following description. In the drawing:

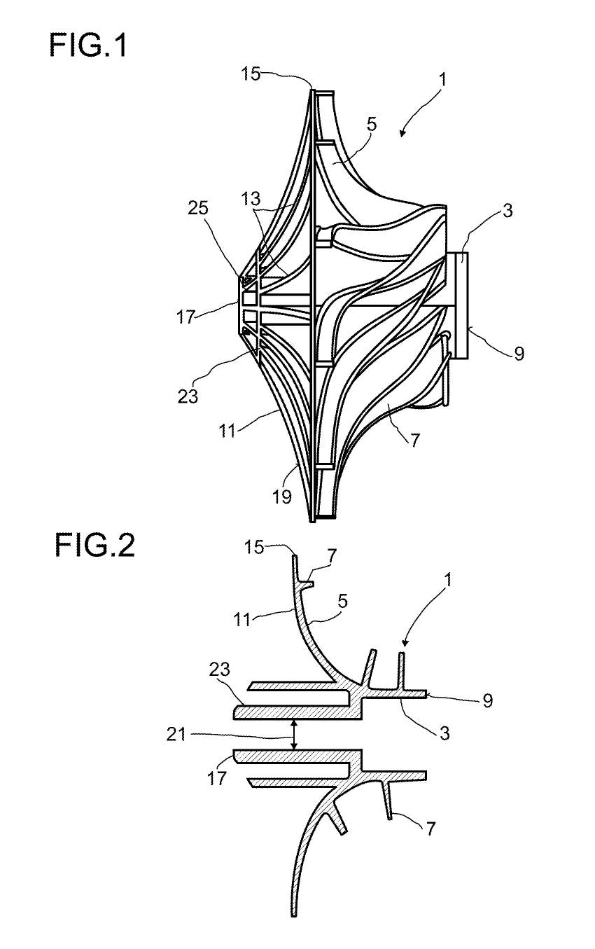

FIG. 1 shows a compressor wheel according to the invention in side view,

FIG. 2 shows a section through a compressor wheel according to the invention,

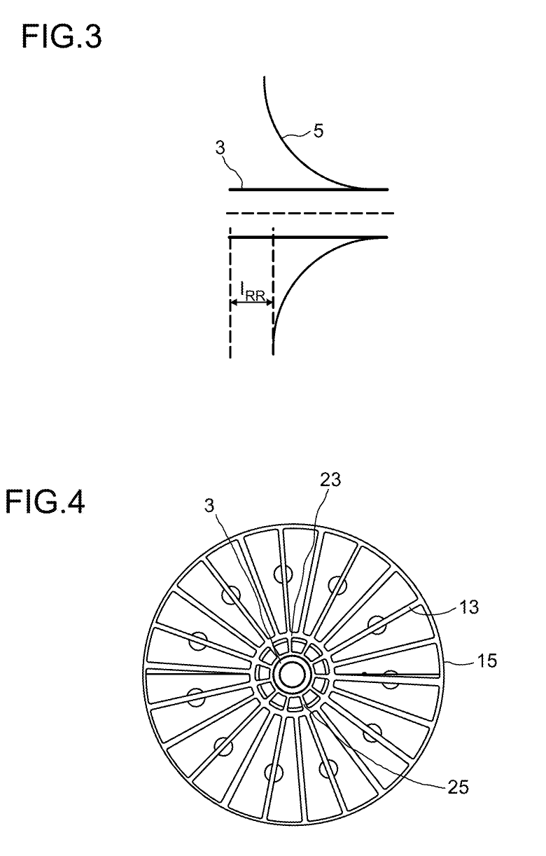

FIG. 3 shows a depiction of the wheel hub and of the wheel body,

FIGS. 4 to 7 show various configurations of the reinforcing ribs on the wheel rear side.

A compressor wheel according to the invention is shown in side view in FIG. 1.

A compressor wheel 1 comprises a wheel hub 3 and a wheel body 5. Guide vanes 7 are arranged on the wheel body 5 on the wheel rear side 6. The guide vanes 7 are shaped in such a way that during operation of the compressor wheel the gas to be compressed is transported from the side with the largest diameter in the direction of an upper end 9 of the compressor wheel 1. For this purpose, the compressor wheel 1 normally turns at a speed of rotation of usually several thousand revolutions per minute. Thus, in the case of use in an electrically driven compressor in a motor vehicle engine, for example, speeds of rotation of up to 100,000 rpm can be reached, for example. Here, the configuration and shape of the guide vanes 7 corresponds to the generally customary shape for corresponding compressor wheels and is known to those skilled in the art. As can be seen from FIG. 1, the guide vanes 7 have a swept, s-shaped profile and change direction, wherein the guide vanes 7 are aligned in an axial direction in the region of the largest circumference and in a radial direction at the other end, in the region of the upper end 9.

According to the invention, reinforcing ribs 13 are arranged on the wheel rear side 11, which faces away from the guide vanes. The reinforcing ribs 13 extend from an outer circumference 15 toward the wheel hub 3. As can be seen from FIG. 1, the wheel hub 3 projects in an axial direction on the wheel rear side 11, and the reinforcing ribs 13 extend to the lower end 17 of the wheel hub 3. In the embodiment shown here, the reinforcing ribs have a curved trailing edge 19. In this case, the profile is concave with the smallest gradient in the region of the outer circumference 15 and the largest gradient in the region of the wheel hub 3.

Apart from the concave profile, shown here, of the trailing edge 19 of the reinforcing ribs 13, a linear profile is also possible, for example. The curved profile can be in the form of a circular segment, parabolic, elliptical or hyperbolic. A profile in the form of a circular segment, as shown in FIG. 1, is preferred.

A section through the compressor wheel shown in FIG. 1 is shown in FIG. 2.

It can be seen here that the wheel body 5 curves in a direction from the outer circumference 15 to the upper end 17. In order to avoid large wall thicknesses, which can lead to cavities and distortion due to shrinkage when the compressor wheel 1 is produced from a polymer material, the wheel body is in the form of a curved wall which has a substantially constant thickness. In order to obtain a sufficient stability of the wheel, the reinforcing ribs 13 are provided.

In the embodiment shown in FIG. 2, the wheel hub has a smaller inside diameter 21 in the region of the wheel rear side 11 than in the region of the wheel front side. In this case, the inside diameter of the wheel hub increases with an abrupt widening.

In addition to the reinforcing ribs 13, the compressor wheel 1 has a concentric ring 23, which surrounds the wheel hub 3. The reinforcing ribs 13 then extend initially from the outer circumference 15 to the concentric ring 23 and, from there, onward to the wheel hub 3. In this case, the number of reinforcing ribs 13 from the outer circumference 15 to the concentric ring 23 can be greater than the number of reinforcing ribs between the concentric ring 23 and the wheel hub 3.

Apart from designing the wheel hub 3 with an abrupt widening, as shown in FIG. 2, it is also possible to design the wheel hub 3 with a constant diameter. This can be seen from FIG. 3 by way of example. Here, FIG. 3 shows only the wheel hub 3 and the wheel body 5 for the sake of greater simplicity. The length by which the wheel hub projects on the wheel rear side is denoted by I_{RR}. Here too, the wheel body 5 extends with a concave curvature from the outer circumference 15 to the upper end 9 of the wheel hub 3.

In FIGS. 4 to 7, various possible profiles of the reinforcing ribs 13 on the wheel rear side 11 are shown.

FIG. 4 shows the profile of the reinforcing ribs 13 as shown also in FIGS. 1 and 2. Here, the reinforcing ribs 13 extend linearly in a radial direction. In the variant shown here, the wheel hub 3 is surrounded by a concentric ring 23. In this case, the reinforcing ribs 13 extend from the outer circumference 15 to the concentric ring 23. Each second reinforcing rib 13 extends further from the concentric ring 23 to the wheel hub 3. Owing to the reduced number of reinforcing ribs 13 between the concentric ring 23 and the wheel hub 3, the distance between the individual reinforcing ribs 13 is greater than if all the reinforcing ribs 13 extended to the wheel hub 3. This is helpful especially in the manufacture of the compressor wheel 1.

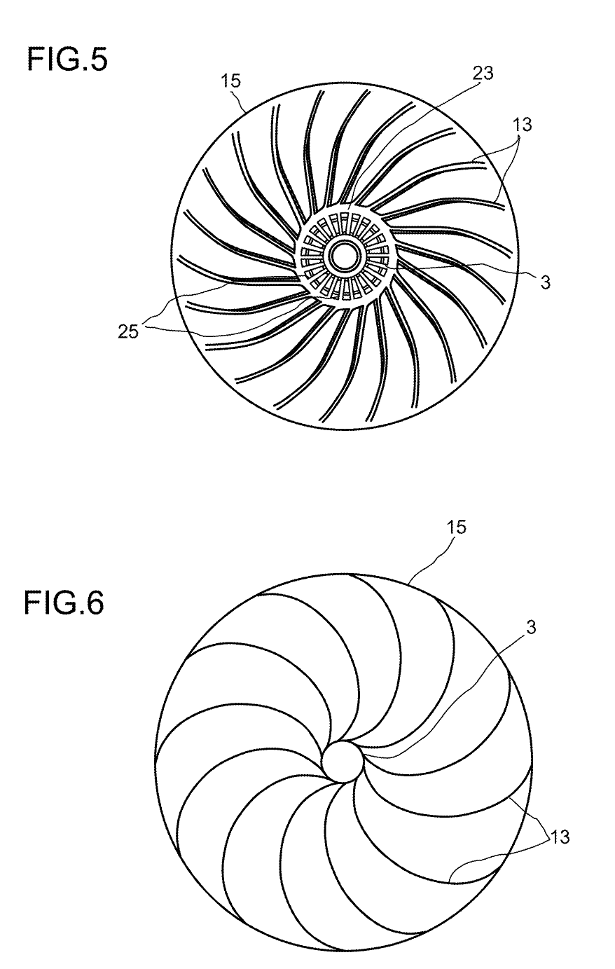

FIG. 5 shows an arrangement of the reinforcing ribs in which reinforcing ribs 25 between the concentric ring 23 and the wheel hub 3 extend linearly in a radial direction and the reinforcing ribs extending from the outer circumference 15 to the concentric ring 23 are curved. In the embodiment shown here, the reinforcing ribs have a slight S shape.

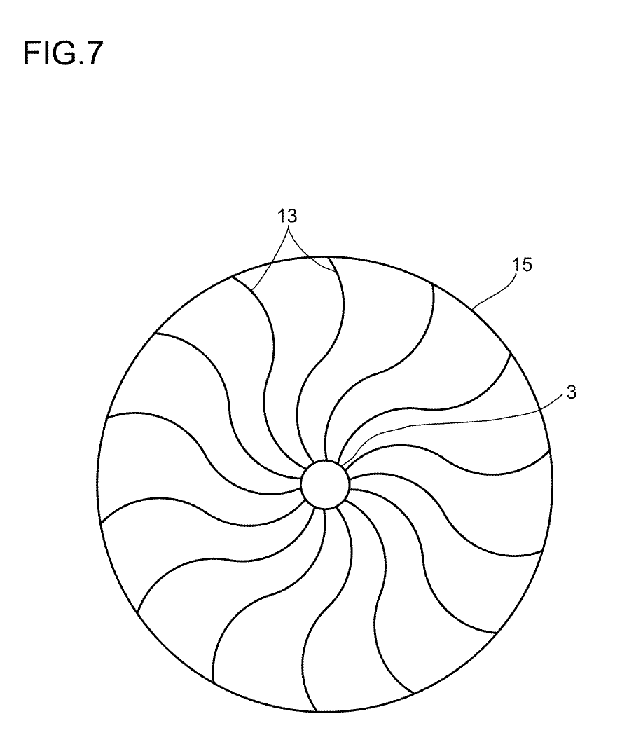

With the shape shown in FIG. 6, the reinforcing ribs 13 extend in the form of a circular segment, and in the embodiment shown in FIG. 7, they likewise extend in an s shape.

With the shapes of the reinforcing ribs 13 shown in FIGS. 6 and 7, it is also possible additionally to provide the concentric ring 23.

As an alternative to the radial path of the ribs in FIG. 1, it is also possible to embody the reinforcing ribs with an angle relative to the radial direction. This is also possible with a curved profile, with the angle being determined here by drawing a connecting line between the opposites and the angle being defined between the connecting line and the radial direction.

In addition to the shapes shown here, the reinforcing ribs can also assume other profiles, being wavy or zigzag in shape for example, and, in this case too, a substantially radial path or a path at an angle relative to the radial direction is possible.

### LIST OF REFERENCE SIGNS

1 compressor wheel
3 radial hub
5 wheel body
6 wheel front side
7 guide vane
9 upper end
11 wheel rear side
13 reinforcing ribs
15 outer circumference
17 lower end
19 trailing edge
21 inside diameter of the wheel hub in the region of the wheel rear side
23 concentric ring
25 reinforcing ribs between concentric ring 23 and wheel hub 3
I_{RR} length by which the wheel hub 3 projects on the wheel rear side 11

1: A compressor wheel for a high-speed compressor comprising a polymer material, having a wheel front side, a wheel rear side and a wheel hub, wherein the wheel front side has a curvature, by virtue of which the distance between a plane extending radially through the outer circumference of the wheel front side and the surface of the wheel front side increases from the outer circumference toward the wheel hub, and guide vanes are arranged on the wheel front side, wherein the wheel hub projects in an axial direction on the wheel rear side, and reinforcing ribs extend from the wheel hub toward the outer circumference, wherein the distance between a plane extending radially through the outer circumference of the wheel rear side and the trailing edge of the reinforcing ribs increases from the outer circumference of the wheel rear side toward the wheel hub, wherein the wheel hub is surrounded on the wheel rear side by a concentric ring, and reinforcing ribs extend between the wheel hub and the concentric ring and from the concentric ring toward the outer circumference.

2: The compressor wheel as claimed in claim 1, wherein the reinforcing ribs have a curved trailing edge.

3. (canceled)

4: The compressor wheel as claimed in claim 1, wherein the number of reinforcing ribs between the wheel hub and the concentric ring is smaller than the number of reinforcing ribs which extend from the concentric ring toward the outer circumference.

5: The compressor wheel as claimed in claim 1, wherein the reinforcing ribs between the wheel hub and the concentric ring are aligned in a radial direction.

6: The compressor wheel as claimed in claim 1, wherein all the reinforcing ribs extend in a radial direction.

7: The compressor wheel as claimed in claim 1, wherein the reinforcing ribs extending toward the outer circumference are curved or s-shaped.

8: The compressor wheel as claimed in claim 1, wherein the polymer material is selected from the group consisting of polyaryletherketones, polysulfones, polyphenylenesulfone, polyetherimides, polyamides, polyethersulfones, polyphenylene sulfides, polyvinylidene fluoride, epoxy resins and polyesters.

9: The compressor wheel as claimed in claim 1, wherein the polymer material is fiber-reinforced.

10: The compressor wheel as claimed in claim 1, wherein the compressor wheel is a compressor wheel in an exhaust turbocharger, an electrically driven compressor for engines, a vacuum cleaner, a blower, a compressor, a fan or a vapor extraction hood.
